(19) United States
(12) Patent Application Publication
(10) Pub. No.: US 2026/0292783 A1
(43) Pub. Date: Sep. 24, 2026

(54) COMMUNICATION SYSTEM

(71) Applicant: NATIONAL INSTITUTE OF INFORMATION AND COMMUNICATIONS TECHNOLOGY, Koganei-shi, Tokyo (JP)

(72) Inventors: Toru OSUGA, Tokyo (JP); Satoko ITAYA, Tokyo (JP); Fumiko OHORI, Tokyo (JP); Takeshi MATSUMURA, Tokyo (JP)

(73) Assignee: NATIONAL INSTITUTE OF INFORMATION AND COMMUNICATIONS TECHNOLOGY, Koganei-shi, Tokyo (JP)

(21) Appl. No.: 19/469,987

(22) PCT Filed: Mar. 4, 2024
(86) PCT No.: PCT/JP2024/007930

§ 371 Date: Sep. 26, 2025

(30) Foreign Application Priority Data
Mar. 29, 2023 (JP) 2023-053464

(51) Int. Cl. H04W 64/00; H04B 17/318; H04L 43/0882; H04W 24/10; H04W 84/00

(52) U.S. Cl. CPC H04W 64/006; H04B 17/318; H04L 43/0882; H04W 24/10; H04W 84/005

(57) ABSTRACT

In a communication system, a controller that performs management at a center creates a control policy based on wireless environment information, such as a communication condition and a channel congestion rate, position information of mobile wireless equipment, and position information of an access point, a building, and a facility to wireless equipment moving while receiving a movement instruction and the like through a wireless communication like an AGV, and the mobile wireless equipment performs the wireless communication while switching a communication path according to the control policy.

### TECHNICAL FIELD

The present invention relates to a communication system. The present invention especially relates to a technique of maintaining Quality of Service (QOS) regardless of a movement of wireless equipment that moves while receiving a movement instruction and the like through wireless communication like an Automated Guided Vehicle (AGV) by performing wireless communication while causing the wireless equipment to switch a communication path to appropriate one.

### BACKGROUND ART

In manufacturing sites and distribution warehouses, to reduce excess components and works in process, a system of supplying components and works in process only by a required amount when they are required using a transport vehicle is introduced. For labor saving and improvement of production efficiency, automation using an unmanned transport vehicle, such as an AGV, has been advanced. Here, since the AGV cannot perform wired communication because the AGV moves inside and outside of buildings at a manufacturing site and a distribution warehouse, the AGV receives a movement instruction and the like by wireless communication. Additionally, at the manufacturing site and the distribution warehouse, since the same component and work in process are required or completed at regular intervals, there is a feature that a movement route and a movement timing of the AGV are periodic.

Here, there are two problems in the wireless communication with the automated guided vehicle.

The first is a time taken for searching and switching. For example, at the manufacturing site, there are many pieces of wireless equipment, such as a wireless tool, other than the automated guided vehicle, and many channels are available to house these devices in many cases. Therefore, the automated guided vehicle needs to search the many channels to find an appropriate access point, and it takes a time for searching. Further, since the automated guided vehicle needs to change the access point one after another as the automated guided vehicle moves, the search time occurs for each time. Since the communication is cut off when the access point is switched, it takes a time for receiving the movement instruction and the like. Since the automated guided vehicle is designed to stop for safety when the movement instruction and the like are not received for a certain period of time, the cut-off time needs to be reduced.

The second is a connection to an inappropriate access point. To cover the movement range of the automated guided vehicle, it is necessary to install a large number of access points. At the manufacturing site and the distribution warehouse there are many metal bodies, such as components, works in process, manufacturing machineries, and walls of buildings, and a part of the metal bodies are moving. Therefore, a far access point having a received signal strength temporarily increased due to a visibility or a reflection is misidentified and connected as an appropriate access point, thus possibly causing degradation of QoS immediately. Even in a case where the access point is appropriate at the time of connection, when the access point is rearward when viewed in the moving direction of the automated guided vehicle, QoS possibly immediately degrades in association with the move of the automated guided vehicle.

Conventionally, techniques as disclosed in Patent Document 1 and Non-Patent Document 1 below are provided against the problems in the wireless communication with the automated guided vehicle.

Patent Document 1 discloses a technique in which a controller that performs an overall control in the center creates a control policy and notifies each wireless equipment of the control policy, and the wireless equipment performs a control based on the control policy notified from the controller and wireless environment information at a periphery collected by the wireless equipment itself.

Non-Patent Document 1 discloses a technique in which a plurality of wireless interfaces are provided in wireless equipment, the respective wireless interfaces are connected to different access points and channels in advance, and the wireless interface to be used is switched corresponding to the quality of wireless access, thereby switching a communication path without occurrence of a cut-off time.
Patent Document 1: JP-A-2019-176390
Non-Patent Document 1: Toru Osuga et al., “Design of Smart Resource Flow Wireless Platform for Flexible Factory Communication,” The 22nd International Symposium on Wireless Personal Multimedia Communications, November 2019.

### DISCLOSURE OF THE INVENTION

### Problems to be Solved by the Invention

In the technique disclosed in Patent Document 1, the controller determines a channel or the like used for communication as the control policy, and the wireless equipment switches the channel according to the control policy notified from the controller, thus eliminating the need for searching and allowing saving a time for the searching.

In the technique disclosed in Non-Patent Document 1, while the wireless equipment provided with a plurality of wireless interfaces is necessary, connecting to a plurality of access points in advance allows switching the communication path without occurrence of the cut-off time. Therefore, combining these techniques allows solving the problem of the time taken for the searching and the switching as the first problem.

Meanwhile, since the system as the combination of Patent Document 1 and Non-Patent Document 1 has failed to solve the problem of the connection to an inappropriate access point as the second problem, it is necessary to introduce a mechanism of choosing an appropriate access point especially when creating the control policy of Patent Document 1 into the system.

To solve the above-described problem, it is an object of the present invention to provide a communication system allowing a connection to a more appropriate access point than an access point determined based on only wireless environment information observed by individual mobile wireless equipment while eliminating a need for searching the wireless environment information and reducing a time for searching and switching and capable of maintaining QoS even when the wireless equipment moves.

### Solutions to the Problems

To solve the above-described problem, the inventors invented a communication system in which a controller that performs a management at a center creates a control policy based on wireless environment information, such as a communication condition and a channel congestion rate, position information of mobile wireless equipment, and position information of an access point, a building, and a facility to wireless equipment moving while receiving a movement instruction and the like through a wireless communication like an AGV, and the mobile wireless equipment performs the wireless communication while switching a communication path according to the control policy.

A communication system according to a first invention includes mobile wireless equipment, a mobile wireless equipment management device, and a controller. The mobile wireless equipment is mounted in a moving body. The mobile wireless equipment includes wireless communication control means and data transmitting/receiving means. The mobile wireless equipment performs a data communication via a wireless network. The mobile wireless equipment management device manages the mobile wireless equipment. The controller includes a wireless environment information management unit and first information policy transmitting/receiving means. The wireless environment information management unit manages wireless environment information on the wireless network. The first information policy transmitting/receiving means transmits and receives the wireless environment information on the wireless network and a control policy. The controller manages an entire management target area. The mobile wireless equipment includes position information measurement management means and second information policy transmitting/receiving means. The position information measurement management means measures position information of the mobile wireless equipment and manages the measured position information. The second information policy transmitting/receiving means acquires the position information from the position information measurement management means at predetermined time intervals and/or every communication event of the mobile wireless equipment, and notifies the first information policy transmitting/receiving means of the position information. The controller includes a map information management unit and policy creating means. The map information management unit stores a facility layout map of the management area, and receives the position information of the mobile wireless equipment with the first information policy transmitting/receiving means and stores the position information of the mobile wireless equipment as a movement route map. The policy creating means acquires the wireless environment information from the wireless environment information management unit, acquires the position information of the mobile wireless equipment from the information map information management unit, and creates the control policy based on the wireless environment information and the position information.

In a communication system according to a second invention, which is in the first invention, the position information includes information in at least two directions perpendicular to one another in a horizontal direction and/or information in a vertical direction.

In a communication system according to a third invention, which is in the first invention or the second invention, the map information management unit stores the position information of a plurality of pieces of the mobile wireless equipment.

In a communication system according to a fourth invention, which is in the first invention, the map information management unit preliminarily stores any one or more pieces of information among information on a location of an access point and locations of a fixed wall and/or pillar and fixed facility by an administrator.

In a communication system according to a fifth invention, which is in the first invention, the policy creating means creates the control policy by determining the access point to be connected using at least two or more pieces of information among information on congestion rates and/or received signal strengths of a plurality of wireless channels including a channel that the mobile wireless equipment is using, information on a distance from the access point of the mobile wireless equipment, information on a relation between a traveling direction of the mobile wireless equipment and a direction of the access point, and information on a visibility due to a wall and/or pillar and a fixed facility.

In a communication system according to a sixth invention, which is in the fifth invention, the policy creating means updates the control policy, after making the control policy, by any one or more of methods among a method of removing an access point switched to another access point in a period shorter than a set threshold from connection destinations based on a result when the wireless equipment moves according to the movement route map, a method of removing an access point in which any of a throughput, a delay time, and an error rate is worse than a set threshold from the connection destinations, and a method of adding an access point having the received signal strength higher than a set threshold to the connection destinations.

In a communication system according to a seventh invention, which is in the first invention, the wireless communication control means controls an operation of the data transmitting/receiving means based on the control policy notified from the first information policy transmitting/receiving means.

### Effects of the Invention

As described above, according to the first invention to the seventh invention, a controller that performs a management at a center creates a control policy based on wireless environment information, such as a communication condition and a channel congestion rate, position information of mobile wireless equipment, and position information of an access point, a building, and a facility to wireless equipment moving while receiving a movement instruction and the like through a wireless communication like an AGV, and the mobile wireless equipment performs the wireless communication while switching a communication path according to the control policy. This allows a connection to a more appropriate access point than an access point determined based on only wireless environment information observed by individual mobile wireless equipment while eliminating a need for searching the wireless environment information and reducing a time for searching and switching, thereby allowing maintaining QoS even when the wireless equipment moves.

### BRIEF DESCRIPTION OF THE DRAWINGS

FIG. 1 is a conceptual diagram of a factory in which a communication system to which the present invention is applied is established.

FIG. 2 is a schematic block diagram of the communication system illustrating Embodiment 1 of the present invention.

FIG. 3 is a diagram illustrating an example of information on creating a control policy to determine an access point in Embodiment 1.

FIG. 4 is a diagram illustrating an example of a control policy in an access point update method in Embodiment 1.

### DESCRIPTION OF PREFERRED EMBODIMENTS

The following describes an embodiment of a communication system to which the present invention is applied in detail using the block diagram. For reference numerals in the block diagram, the same reference numerals are used in block diagrams with similar functions unless there are specific circumstances.

### Embodiment 1

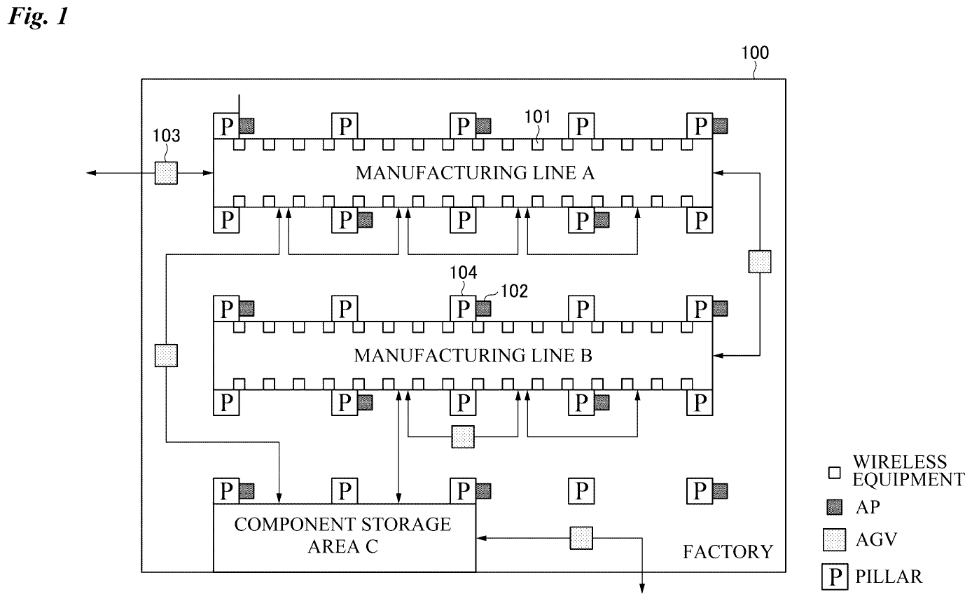

As illustrated in FIG. 1, the communication system of the embodiment is used to be applied to a wireless network system of a factory 100 and the like. In the example of FIG. 1, there are a plurality of manufacturing lines A, B, a component storage area C, and the like, and the example of FIG. 1 illustrates a conceptual diagram in which an automated guided vehicle (AGV) 103 conveys (transports) components between the manufacturing lines A, B and between the component storage area C and the manufacturing lines A, B to improve the efficiency of the manufacturing process on the manufacturing lines A, B. A large number of pieces of wireless equipment 101 (a manufacturing tool, a robot, and the like provided with wireless IoT devices) are installed on the manufacturing lines A, B, and the manufacturing lines are monitored in real time. The wireless equipment 101 communicates with a wireless LAN access point (AP) 102 that covers a specific area (specific space) in the factory, and exchanges data with a higher-level controller that monitors the factory. The automated guided vehicle (AGV) 103 is provided with mobile wireless equipment of the embodiment, and moves while switching the wireless LAN access point to, for example, automatically convey components.

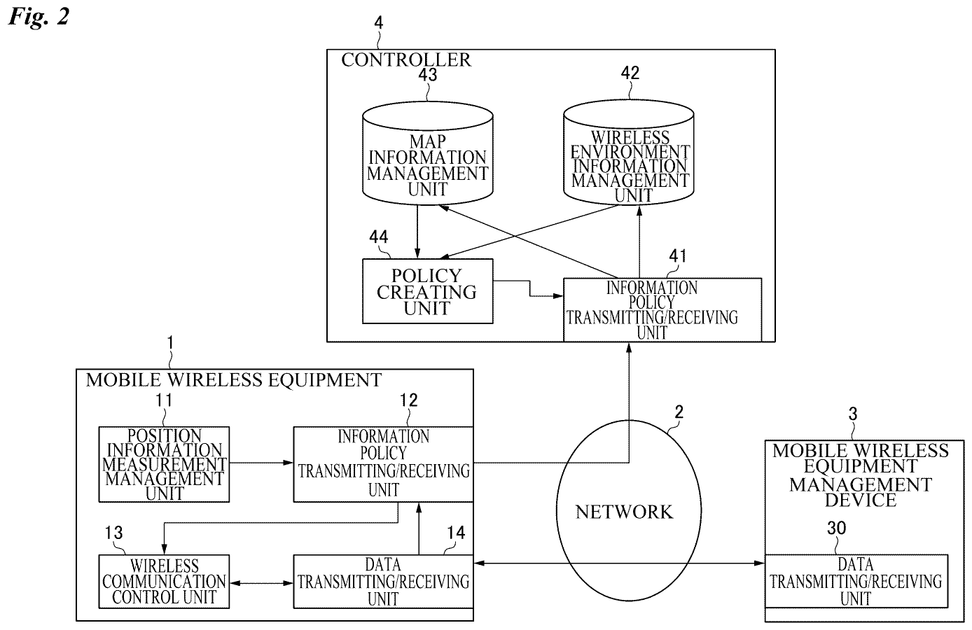

Here, the example of FIG. 1 illustrates a layout of the factory, and illustrates a facility layout map of a management area. Arrows in FIG. 1 illustrate a schematic map of an exemplary movement route map of the automated guided vehicle (AGV). The facility layout map means layout drawing of installation situation of manufacturing equipment, manufacturing lines, incidental equipment, wireless equipment, wireless access points (AP), and automated guided vehicles (AGV) installed in the factory in general. Although not illustrated in FIG. 1, fixed walls and pillars are also included. It is preferred to map a facility that obstructs the automatic conveyance by the AGV including the position and the like and store the map as electronic data. The movement route map means a map of the path (route) when the automated guided vehicle (AGV) travels autonomously. For example, for transporting the components and the like in the factory, the AGV conveys the component from a current process to the next process on the same manufacturing line, goes back and forth between the manufacturing line and the component storage area to sequentially convey the components to the processes on the manufacturing line, and transports the completed component to another factory. The automated guided vehicle (AGV) holds route information as coordinate data on an electronic map. The facility layout map and the movement route map of the management area are stored in a map information management unit in FIG. 2, and the AGV reads the facility layout map and the movement route map as necessary to perform the automatic conveyance.

While a wireless environment in a factory, such as a pillar (made of metal or made of concrete) 104 and a moving body (component) made of metal in the factory 100, continually varies and complementary radio waves, such as a noise radio wave, are transmitted under the environment, and this causes a connection to an inappropriate access point, a controller that performs a management at a center creates a control policy based on wireless environment information, such as a communication condition and a channel congestion rate, position information of mobile wireless equipment, and position information of an access point, a building, and a facility to wireless equipment moving while receiving a movement instruction and the like through a wireless communication like an AGV, and the mobile wireless equipment performs the wireless communication while switching a communication path according to the control policy. This allows a connection to a more appropriate access point than an access point determined based on only wireless environment information observed by individual mobile wireless equipment while eliminating a need for searching and reducing a time for searching and switching, thereby allowing maintaining QoS even when the wireless equipment moves.

An image of unmanned transportation of component by the automated guided vehicle (AGV) is illustrated with machineries, metal bodies, pillars and the like of the manufacturing line. The manufacturing line is provided with a large number of pieces of wireless equipment, and a large number of wireless access points are installed at the pillar and the like of the factory at predetermined intervals.

### <Embodiment 1: Configuration>

The communication system of the present invention includes mobile wireless equipment 1 and a mobile wireless equipment management device 3 that perform a data communication via a wireless network 2, and a controller 4 that manages the whole system at the center as illustrated in FIG. 2 as a minimum configuration. The mobile wireless equipment 1 includes position information measurement management unit 11 in addition to conventionally provided information policy transmitting/receiving unit 12, wireless communication control unit 13, and data transmitting/receiving unit 14, the controller 4 includes a map information management unit 43 in addition to conventionally provided information policy transmitting/receiving unit 41 and wireless environment information management unit 42, and a policy creating unit 44 creates a control policy based on not only conventional wireless environment information but also position information and information on a movement route of the mobile wireless equipment. The mobile wireless equipment management device 3 includes a data transmitting/receiving unit 30.

### <Embodiment 1: Description of Configuration>

### <Embodiment 1: Description of Configuration: Mobile Wireless Equipment>

The position information measurement management unit 11 measures position information of the mobile wireless equipment 1, and notifies the information policy transmitting/receiving unit 12 of the position information. Here, the position information includes information in at least two directions perpendicular to one another in the horizontal direction, and additionally, may include information in the vertical direction. Not only the information on position, but also information on movement direction and movement speed may be included. The position information may be absolute position information measured using a positioning system such as Global Positioning System (GPS), or may be relative position information calculated with a distance from a specific land mark or calculated with a movement direction, movement speed, and a time from a set point. The scale and the direction of axis may be those defined like the latitude/longitude, or may be those uniquely determined like an X-axis direction/Y-axis direction.

The information policy transmitting/receiving unit 12 collects wireless environment information on the wireless network 2 from the data transmitting/receiving unit 14 at predetermined time intervals and/or every event (communication event), such as a packet transmission/reception and a start/end of flow, and notifies the information policy transmitting/receiving unit 41 of the controller 4 of the wireless environment information. Here, the wireless environment information is, for example, conditions of communication, such as a throughput, a delay time, and an error rate of a flow that the data transmitting/receiving unit 14 communicates, a congestion rate of a channel used, and a received signal strength. Here, the process in the information policy transmitting/receiving unit 12 is similar to the process disclosed in Patent Document 1. The position information is acquired from the position information measurement management unit 11 at predetermined time intervals and/or every event, such as a change of movement direction or movement speed, and notified to the information policy transmitting/receiving unit 41 of the controller 4.

The information policy transmitting/receiving unit 41 of the controller 4 stores the wireless environment information notified from the information policy transmitting/receiving unit 12 of the mobile wireless equipment 1 in the wireless environment information management unit 42. Here, the process in the wireless environment information management unit 42 is similar to the process disclosed in Patent Document 1. Further, the position information notified from the information policy transmitting/receiving unit 12 of the mobile wireless equipment 1 is stored in the map information management unit 43.

The information policy transmitting/receiving unit 41 of the controller 4 stores the position information in the map information management unit 43. Here, when a plurality of pieces of mobile wireless equipment 1 are present, and units and the like of the position information notified from the respective pieces of the mobile wireless equipment 1 are different, the position information may be stored with an aligned unit. Information on a location of the access point and locations of fixed wall and pillar and fixed facility may be preliminarily stored by an administrator and the like, and when the movement route of the mobile wireless equipment 1 is fixed, information on the movement route may be stored.

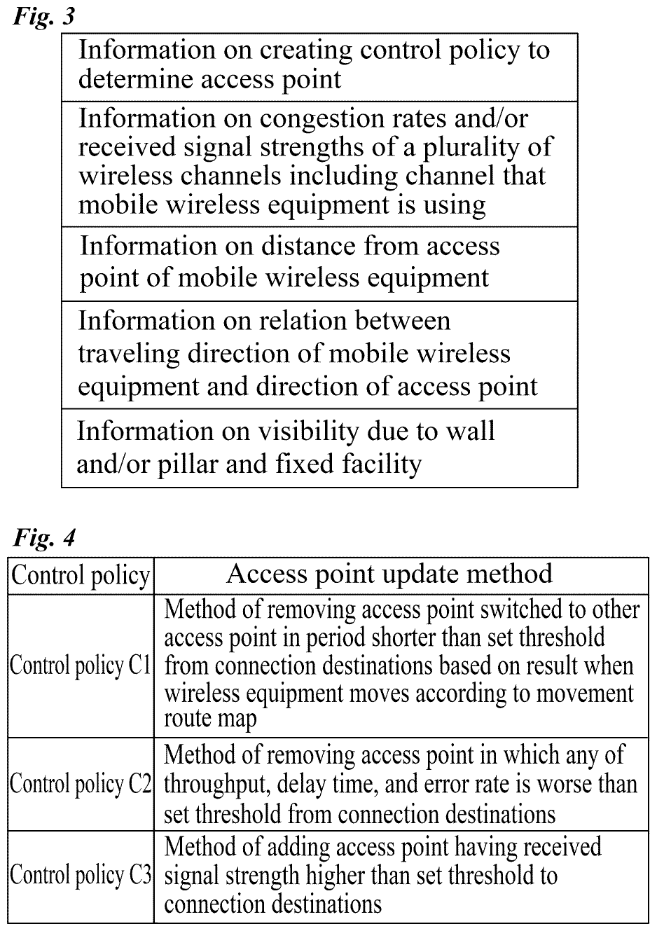

A policy creating unit 44 acquires the wireless environment information from the wireless environment information management unit 42, acquires the position information from the map information management unit 43, creates the control policy based thereon, and notifies the information policy transmitting/receiving unit 41 of the controller 4 of the control policy. The creation of the control policy is performed by, as illustrated in FIG. 3, determining the access point to be connected using at least two or more pieces of information among the information on the control policy to determine the access point. For example, the policy creating unit 44 performs a method for creating the control policy by determining the access point to be connected using at least two or more pieces of information among information on congestion rates and/or received signal strengths of a plurality of wireless channels including a channel that the mobile wireless equipment 1 is using, information on a distance from the access point of the mobile wireless equipment 1, information on a relation between a traveling direction of the mobile wireless equipment and a direction of the access point, and information on a visibility due to the wall and/or pillar, the fixed facility, and the like. Not limited to the above-described method, for example, a method in which, for the access points in the connection destinations determined by the above-described method, an access point having a result of being switched to another access point in a short period in a past round on the same route is removed from the connection destinations may be employed. Further, a method in which, for the access points in the connection destinations determined by the above-described method, an access point having a result that QoS, such as a throughput, a delay time, and an error rate, in the actual communication was worse than a predetermined threshold in a past round on the same route is removed from the connection destinations may be employed. Furthermore, a method in which, for the access points not in the connection destinations determined by the above-described method, an access point having the received signal strength maintained in a state better than a predetermined threshold for a period longer than a predetermined threshold is added to the connection destinations may be employed. Specifically, as illustrated in FIG. 4, after creating the control policy, the policy creating unit 44 may update the control policy by any one or more of methods among a method of removing an access point switched to another access point in a period shorter than a set threshold from the connection destinations based on a result when the wireless equipment moves according to the movement route map (control policy C1), a method of removing an access point in which any of the throughput, the delay time, and the error rate is worse than a set threshold from the connection destinations (control policy C2), and a method of adding an access point having the received signal strength higher than a set threshold to the connection destinations (control policy C3).

The information policy transmitting/receiving unit 41 of the controller 4 notifies the information policy transmitting/receiving unit of the mobile wireless equipment of the control policy notified from the policy creating unit 44. The information policy transmitting/receiving unit of the mobile wireless equipment notifies the wireless communication control unit 13 of the control policy notified from the information policy transmitting/receiving unit 41 of the controller. Here, the process in the wireless communication control unit 13 is similar to the process disclosed in Patent Document 1.

The wireless communication control unit 13 controls the operation of the data transmitting/receiving unit 14 based on the control policy notified from the information policy transmitting/receiving unit 12. Here, the control method for the operation may be a control method performed as specified by the control policy, or may be a control method performed by collecting the latest wireless environment information of the network from the data transmitting/receiving unit and considering the information when a plurality of candidates are specified by the control policy.

In the present invention, a controller that performs a management at a center creates a control policy based on wireless environment information, such as a communication condition and a channel congestion rate, position information of mobile wireless equipment, and position information of an access point, a building, and a facility to wireless equipment moving while receiving a movement instruction and the like through a wireless communication like an AGV, and the mobile wireless equipment performs the wireless communication while switching a communication path according to the control policy. This allows a connection to a more appropriate access point than an access point determined based on only wireless environment information observed by individual mobile wireless equipment while eliminating a need for searching and reducing a time for searching and switching, thereby allowing maintaining QoS even when the wireless equipment moves.

### <Exemplary Application in Which Effects of Invention are Provided Most>

The present invention is applicable to a system in which mobile wireless equipment, such as an AGV, is used in an environment including a large number of metal bodies like a manufacturing site and a distribution warehouse. The mobile wireless equipment is not limited to the AGV, and may be a tag or the like attached to the component and the work in process or may be an information terminal provided to a worker, a security staff, and the like whose round route is fixed to some extent.

### DESCRIPTION OF REFERENCE SIGNS

1: Mobile wireless equipment
2: Wireless network
3: Mobile wireless equipment management device
4: Controller
11: Position information measurement management unit
12: Information policy transmitting/receiving unit
13: Wireless communication control unit
14: Data transmitting/receiving unit
30: Data transmitting/receiving unit
41: Information policy transmitting/receiving unit
42: Wireless environment information management unit
43: Map information management unit
44: Policy creating unit
100: Factory
101: Wireless equipment
102: Wireless access point
103: Automated guided vehicle (AGV)
104: Pillar (made of metal or made of concrete: radio wave reflecting member)

1. A communication system comprising:
mobile wireless equipment mounted in a moving body, the mobile wireless equipment including wireless communication control means and data transmitting/receiving means, the mobile wireless equipment performing a data communication via a wireless network;
a mobile wireless equipment management device that manages the mobile wireless equipment; and
a controller that includes a wireless environment information management unit and first information policy transmitting/receiving means, the wireless environment information management unit managing wireless environment information on the wireless network, the first information policy transmitting/receiving means transmitting and receiving the wireless environment information on the wireless network and a control policy, the controller managing an entire management target area, wherein
the mobile wireless equipment includes:
position information measurement management means that measures position information of the mobile wireless equipment and manages the measured position information; and
second information policy transmitting/receiving means that acquires the position information from the position information measurement management means at predetermined time intervals and/or every communication event of the mobile wireless equipment, and notifies the first information policy transmitting/receiving means of the
the controller includes:
a map information management unit that stores a facility layout map of the management area, and receives the position information of the mobile wireless equipment with the first information policy transmitting/receiving means and stores the position information of the mobile wireless equipment as a movement route map; and
policy creating means that acquires the wireless environment information from the wireless environment information management unit, acquires the position information of the mobile wireless equipment from the information map information management unit, and creates the control policy based on the wireless environment information and the position information.

2. The communication system according to claim 1, wherein
the position information includes information in at least two directions perpendicular to one another in a horizontal direction and/or information in a vertical direction.

3. The communication system according to claim 1, wherein
the map information management unit stores the position information of a plurality of pieces of the mobile wireless equipment.

4. The communication system according to claim 1, wherein
the map information management unit preliminarily stores any one or more pieces of information among information on a location of an access point and locations of a fixed wall and/or pillar and fixed facility by an administrator.

5. The communication system according to claim 1, wherein
the policy creating means creates the control policy by determining the access point to be connected using at least two or more pieces of information among information on congestion rates and/or received signal strengths of a plurality of wireless channels including a channel that the mobile wireless equipment is using, information on a distance from the access point of the mobile wireless equipment, information on a relation between a traveling direction of the mobile wireless equipment and a direction of the access point, and information on a visibility due to a wall and/or pillar and a fixed facility.

6. The communication system according to claim 5, wherein
the policy creating means updates the control policy, after making the control policy, by any one or more of methods among a method of removing an access point switched to another access point in a period shorter than a set threshold from connection destinations based on a result when the wireless equipment moves according to the movement route map, a method of removing an access point in which any of a throughput, a delay time, and an error rate is worse than a set threshold from the connection destinations, and a method of adding an access point having the received signal strength higher than a set threshold to the connection destinations.

7. The communication system according to claim 1, wherein
the wireless communication control means controls an operation of the data transmitting/receiving means based on the control policy notified from the first information policy transmitting/receiving means.
